(19) United States
(12) Patent Application Publication
(10) Pub. No.: US 2005/0135642 A1
(43) Pub. Date: Jun. 23, 2005

(54) Integrated vehicle instrument panel speaker system

(76) Inventor: Alan George Dry, Grosse Pointe Woods, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/742,097

(22) Filed: Dec. 19, 2003

(51) Int. Cl. H04B 1/00; H04R 5/02; H04R 1/02

(52) U.S. Cl. 381/302; 381/86; 381/389

(57) ABSTRACT

An integrated speaker/climate control system is provided for use in a passenger compartment for distributing sound to occupants of a vehicle. A centralized speaker unit comprises a housing having a plurality of speakers mounted therein. A first sound duct coupled to the centralized speaker unit carries sound generated from a first one of the plurality of speakers to the passenger compartment. A second sound duct coupled to the central speaker unit carries sound generated from a second one of the plurality of speakers to the passenger compartment. A climate control duct coupled to the first sound duct injects a conditioned airflow through the first sound duct and into the passenger compartment. A first vent passage couples an interior of the housing to a predetermined volume separately from the climate control duct.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

1. Field of the Invention

The present invention relates in general to a centralized speaker unit for outputting sound to a passenger compartment of a vehicle through sound ducts, and more specifically, to a centralized speaker unit coupled to sound ducts where the sound ducts carrying both sound and conditioned air to the passenger compartment.

2. Description of the Related Art

Automotive vehicles audio systems typically include two or more speakers that are positioned in different locations throughout the vehicle. Typical speaker locations include the lower front corner of vehicle doors, along the lower interior trim panels near the passengers' legs, and in a front dash panel or a rear window ledge. Positioning the speakers this distance from the ears of the listeners results in inefficient use of sound power.

Packaging space is another issue for vehicle speakers. Location of the speakers inside the trim of the door panels requires a dedicated surface area on the trim panel with no obstructions as well as packaging volume within the door itself. Compartments such as map pockets typically occupy surface areas in the lower portions of the doors. Furthermore, environmental effects such as moisture must be taken into consideration when packaging speakers. Typically sealants and shielding are used to avoid environment effects, however, this becomes costly. Other cost issues become evident when modular door systems are utilized and vehicles require servicing of the speaker. Either removable grill panels for each speaker must be incorporated which adds cost to the door assembly or the entire modular door needs to be removed or replaced.

Another issue with vehicle speakers is the cost associated with the number of speakers utilized. Many vehicles package more than two speakers in a vehicle to provide increased audio loudness to rear seat passengers of the vehicle. The further away a person is from a speaker the less the lower the sound pressure is when reaching the person. While increasing the volume on a front pair of speakers benefits rear seat passengers to hear the reproduced audio, it becomes too loud for those passengers seated in the front passenger seats closer to the speakers. Additional speakers added to the audio system, however, requires additional cost. Thus it is advantageous for a vehicle manufacturers from a cost perspective to use the least amount of speakers as possible, yet still provide audio content with sufficient loudness to each passenger of the vehicle.

### SUMMARY OF THE INVENTION

The present invention relates to a system having a centralized speaker system that provides reproduced audio of sufficient volume to each passenger in a passenger compartment of a vehicle using sound ducts. The present invention also provides conditioned airflow through the sound ducts to the passenger compartment.

In one aspect of the invention, an integrated speaker/climate control system is provided for use in a passenger compartment for distributing sound to occupants of a vehicle. A centralized speaker unit comprises a housing having a plurality of speakers mounted therein. A first sound duct coupled to the centralized speaker unit carries sound generated from a first one of the plurality of speakers to the passenger compartment. A second sound duct coupled to the central speaker unit carries sound generated from a second one of the plurality of speakers to the passenger compartment. A climate control duct is coupled to the first sound duct for injecting a conditioned airflow through the first sound duct and into the passenger compartment. A first vent passage couples an interior of the housing to a predetermined volume separately from the climate control duct.

### BRIEF DESCRIPTION OF THE DRAWINGS

FIG. 1 is an illustration of a passenger compartment instrument panel incorporating integrated speaker/climate system according to the present invention.

FIG. 2 is an illustration of a centralized speaker system integrated within the instrument panel according to a first embodiment of the present invention.

FIG. 3 is an illustration of an integrated speaker/climate control system according to a second embodiment of the present invention.

FIG. 4 is an illustration of an integrated speaker/climate control system illustrating to a third embodiment of the present invention.

### DETAILED DESCRIPTION OF PREFERRED EMBODIMENTS

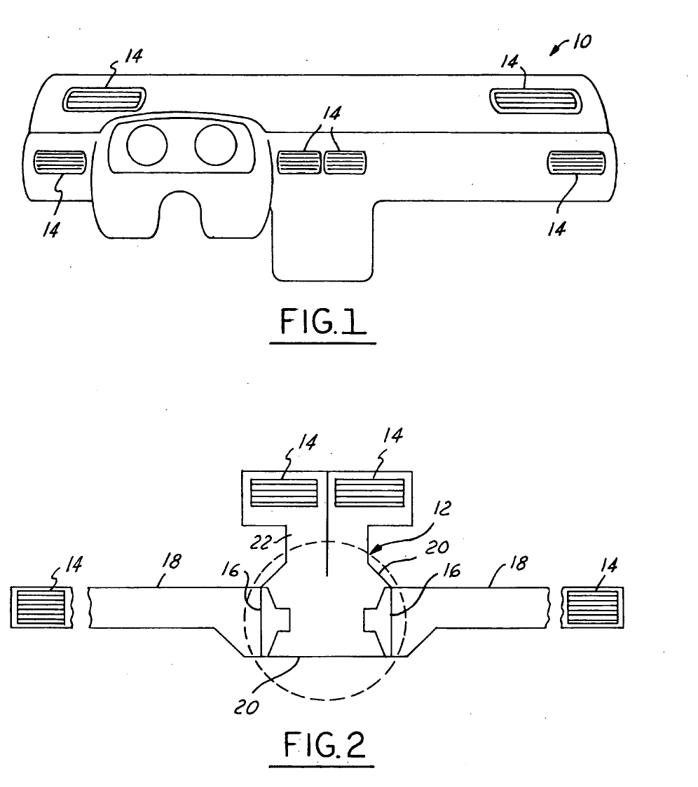

Referring now to the Drawings and particularly to FIG. 1, there is shown a drawing of an instrument panel 10 of a passenger compartment of a vehicle incorporating sound portals 14 (i.e. pass-through ports) for outputting sound such as reproduced audio from a centralized speaker system 12 (shown in FIG. 2). The sound portals 14 are positioned so that the sound (i.e., reproduced audio) is directed at passengers seated in the passenger compartment. In the preferred embodiment, the sound portals 14 are disposed along the instrument panel 10 substantially at chest level and directed toward the passenger's head. Since the sound portals 14 are in close proximity to the passenger's head (50% closer than door mounted speakers) and directed at the passengers, sound volume is mitigated as opposed to mounting speakers at floor board level. The sound portals 14 comprise vents that are directable. Furthermore, the vents may be moveable between an open and closed position so that a person seated in a respective region of the passenger compartment may reduce the sound to the respective region. The vents may include louver-style vents, which are commonly used in heating and cooling airflow passages of vehicles. The sound portals 14 may further be used to provide a conditioned air flow to the passenger compartment of the vehicle.

FIG. 2 illustrates a centralized speaker system 12 integrated within the instrument panel 10 according to a first preferred embodiment. The centralized speaker system 12 includes sound ducts 18 for carrying sound to the passenger compartment of the vehicle. The centralized speaker system 12 comprises a housing having at least two apertures for coupling the sound ducts 18 to the housing 20. The centralized speaker system 12 also comprises at least two speakers 16 mounted within the apertures of the housing 20 where a front side of each speaker extends towards a respective sound duct. A circumference of each speaker maintains a seal against a respective aperture so that a respective speaker isolates the respective sound duct from the interior of the housing 20. In other preferred embodiments, other coupling methods may be used such as the at least two speakers 16 extend through the apertures and mount to a coupling surface formed within the sound ducts 18. The coupling surface of the sound ducts 18 would maintain the seal against the face of each speaker.

Each respective sound duct may be coupled to more than one sound portal for outputting the reproduced audio at different locations on the insstrument panel 10. The sound ducts 18 are fabricated from a plastic material that may be either blow molded or injection molded. Since the sound ducts 18 are plastic, they may be shaped in various passageway configurations for reaching a respective sound portal. The flexibility of using plastic passageways allows avoidance and routing around any obstructions.

The centralized speaker system 12 further includes a first vent passage 22 coupled to an interior of the housing 20. A rear of each respective speaker is disposed within the interior of the housing 20. The first vent passage 22 ventilation path between the interior of the housing 20 to an area of a first predetermined volume. The area of the first predetermined volume functions to vent the rear of each respective speaker systems to the passenger compartment, and also, to segregate the reproduced audio generated by a front of the respective speaker from that of the rear of the respective speaker.

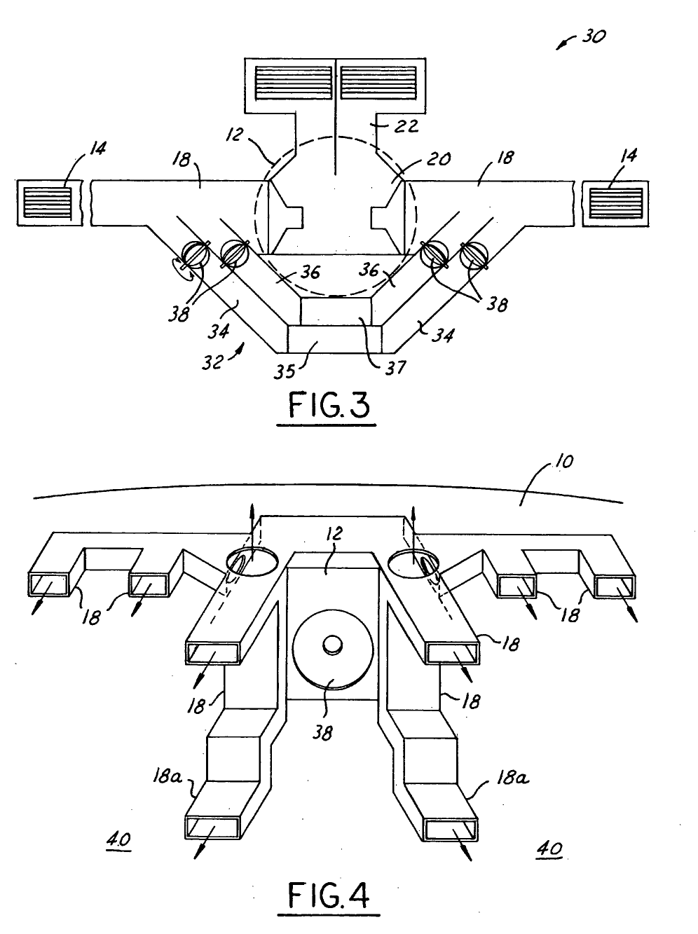

FIG. 3 illustrates an integrated speaker/climate control system 30. The integrated speaker/climate control system comprises climate control ducts 32 coupled to the sound ducts 18 according a second preferred embodiment. The climate control ducts 32 are coupled on the other end to an air conditioning unit and a heater core unit. The climate control ducts 32 include at least one cold air duct 34 and at least one hot air duct 36 for providing a conditioned air flow through each sound duct 18. The climate control ducts 32 are coupled to the first and second sound ducts downstream from the respective speakers. An advantage for coupling the climate control ducts 32 downstream is so each respective speaker is not subjected to temperature and humidity effects of a climate system. Shut off and regulation valves 38 are incorporated into each at least one cold air duct 34 and hot air duct 36 for controlling conditioned air flow. Since the climate control ducts 32 are also be made from plastic, the entire integrated speaker/climate control system 30 may be produced as one unit by a blow molding or injecting molding process.

FIG. 4 illustrates a second integrated speaker/climate control system according to a third preferred embodiment of the present invention. In the second preferred embodiment, the centralized speaker system 12 includes a woofer 38 for reproducing very low frequency sounds (i.e., bass). The woofer is characterized as a large loudspeaker that is typically one foot or larger in diameter. A larger section packaging location utilizing a cross car beam member may be used to create a second predetermined volume packaging location for a reverberation box. This would provide a space of one cubic foot or more. Since the woofer 38 reproduces very audible low frequency sounds, the reproduced audio from the woofer 38 may be directly output from the centralized speaker system 12 to the passenger compartment via a lower portion of the instrument panel 10 as opposed to utilizing sound ducts.

Also shown in FIG. 4 are rear seat passenger ducts 18a extending along the floorboard of the vehicle. The reproduced audio from the centralized speaker system 12 may be transmitted to the rear passenger seating area 40 by routing rear seat passenger sound ducts 18a to one or more rear regions of the passenger compartment so as to enhance rear seat passenger audio output. Rear seat passenger sound ducts may be routed through an overhead trim panel or through an underbody trim panel and coupled to a rear seat passenger compartment sound portal for outputting reproduced audio to the rear seat passengers. Rear seat passenger sound portals can be incorporated into an overhead console, a center console, a floor board console, or a seat console. The rear seat passenger ducts 18a may provide both reproduced audio and conditioned air to the rear seat passengers.

From the foregoing description, one ordinarily skilled in the art can easily ascertain the essential characteristics of this invention and, without departing from the spirit and scope thereof, can make various changes and modifications to the invention to adapt it to various usages and conditions. For example, any combination of midrange speakers, tweeters, and woofers may be used to better enhance the sound quality of the reproduced audio. Furthermore, a centralized location for the speaker system may be located elsewhere other than the instrument panel. Since the speakers are packaged in a dedicated centralized location, it is recognized that another advantage of the centralized speaker system using sound ducts and sound portals is that larger speakers can be utilized which is ordinarily an issue when packaging in trim panels of doors due to packaging restrictions, constraints, and obstructions with other components of the vehicle.

1. An integrated speaker sound duct system for use in a passenger compartment of a vehicle comprising:
a centralized speaker unit comprising a housing having a plurality of speakers mounted therein;
a first sound duct coupled to said centralized speaker unit for carrying sound generated from a first one of said plurality of speakers to said passenger compartment; and
a second sound duct coupled to said central speaker unit for carrying sound generated from a second one of said plurality of speakers to said passenger compartment.

2. The system of claim 1 further comprising a climate control duct coupled to said first sound duct for injecting a conditioned air flow through a portion of said first sound duct and into said passenger compartment.

3. The system of claim 1 further comprising a first vent passage for coupling an interior of said housing to a predetermined volume separately from said climate control duct.

4. An integrated speaker/climate control system for use in a passenger compartment of a vehicle comprising:
a centralized speaker unit comprising a housing having a plurality of speakers mounted therein;
a first sound duct coupled to said centralized speaker unit for carrying sound generated from a first one of said plurality of speakers to said passenger compartment;
a second sound duct coupled to said central speaker unit for carrying sound generated from a second one of said plurality of speakers to said passenger compartment;
a climate control duct coupled to said first sound duct for injecting a conditioned air flow through said first sound duct and into said passenger compartment;
a first vent passage for coupling an interior of said housing to a predetermined volume separately from said climate control duct.

5. The system of claim 4 wherein said central speaker unit comprises a woofer.

6. The system of claim 5 wherein said woofer uses a cross beam for creating a second predetermined volume, said second predetermined volume comprises at least a portion of said housing.

7. The system of claim 6 further comprising a third sound duct coupled to said central speaker unit for carrying sound generated from said woofer to said passenger compartment.

8. The system of claim 4 wherein at least one sound duct extends to a rear region of said passenger compartment.

9. The system of claim 4 wherein at least one sound duct extends to an instrument panel.

10. The system of claim 4 wherein at least one sound extends to a center floor counsel.

11. The system of claim 4 wherein at least one sound duct extends to an overhead counsel.

12. The system of claim 4 wherein said first and second ducts each include a respective pass-through port for allowing passage of sound to said passenger compartment.

13. The system of claim 12 wherein said pass-through ports include a vent, said vent moveable between an open position and a closed position.

14. The system of claim 4 wherein said climate control duct includes at least one control valve for controlling said conditioned air flow to said first and second duct, said at least one control valve moveable between and an open and a closed position.
